(19) United States
(12) Patent Application Publication
(10) Pub. No.: US 2014/0229928 A1
(43) Pub. Date: Aug. 14, 2014

(54) UPGRADING SOFTWARE IN PRODUCTION ENVIRONMENTS

(71) Applicants: Claes Göran Edström, Beaconsfield (CA); Karrar Fida, Pierrefonds (CA); Chunyan Fu, Laval (CA)

(72) Inventors: Claes Göran Edström, Beaconsfield (CA); Karrar Fida, Pierrefonds (CA); Chunyan Fu, Laval (CA)

(21) Appl. No.: 13/764,238

(22) Filed: Feb. 11, 2013

(51) Int. Cl. G06F 9/445

(52) U.S. Cl. CPC G06F 8/65
USPC 717/171

(57) ABSTRACT

A method of upgrading a software package having a first revision level on a production node includes providing a virtual node, installing the software package on the virtual node, copying configuration data from the production node to the virtual node, upgrading the software package on the virtual node to a second revision level, redirecting a portion of traffic associated with the software package from the production node to the virtual node, and determining if the virtual node correctly handles the redirected portion of traffic.

### TECHNICAL FIELD

The present disclosure relates to computer software, and more particularly, to systems/methods for upgrading software in a live environment.

### BACKGROUND

Software upgrades may expand functionality and/or fix issues in deployed software packages. However, it may be problematic to upgrade software in a live (i.e., deployed or operational) system, as upgrading the software in a live node may cause service interruptions, performance degradation, or system downtime if there is a failure in any part of the upgrade process. It is a particular challenge to perform software upgrades on a live node in a telecommunications network, because such nodes are required to continuously provide service to users.

Existing methods for upgrading software have certain benefits and drawbacks. For example, one method of upgrading software in a live node is to download an upgrade package to a reserved memory area and store both current and upgrade software in function cards. This approach may provide a possible solution for smooth software upgrades without an interruption of service. Such types of solutions have been implemented in telecommunication software upgrade packages.

However, despite the benefits of upgrading software levels, the existing solutions are far from sufficient to ensure a risk free upgrade on a live node. For example, should an unforeseen fault arise with the new software package, the likelihood of an application failure (and hence, traffic failure) may be high. It must therefore implicitly be assumed that the upgrade software is written, compiled and linked correctly with no critical bugs. Similarly, it must also be assumed that there is no configuration conflict or version incompatibility with the other nodes in the network, and that there has been no operator mistake in performing the upgrade steps in order to avoid costly traffic downtime.

Further drawbacks of current operating procedures in relation to software upgrades can be observed in project timelines. Software verification is traditionally performed before an upgrade is applied to a live node. In order to accomplish this, a lengthy process must be executed which includes performing a study of the existing network architecture, developing low/high level solution documents, and installing/configuring a complete test bed. All of this careful planning, though beneficial, may results in long lead times and increased cost. Even with such a detailed approach, there remains a great deal of hesitation on the part of users to carry out a software upgrade on an otherwise functioning system. In addition, upgrade related issues can still arise regardless of rigorous testing performed on a test bed.

### SUMMARY

A method of upgrading a software package having a first revision level on a production node according to some embodiments includes providing a virtual node, installing the software package on the virtual node, and copying configuration data from the production node to the virtual node. The software package on the virtual node is upgraded to a second revision level, and a portion of traffic associated with the software package is redirected from the production node to the upgraded virtual node. The method further includes determining if the upgraded virtual node correctly handles the redirected portion of traffic.

The method may further include, in response to determining that the upgraded virtual node correctly handled the redirected portion of traffic, redirecting all traffic associated with the software package from the production node to the upgraded virtual node and determining if the upgraded virtual node correctly handles the redirected all traffic, and in response to determining that the upgraded virtual node correctly handled the redirected all traffic, upgrading the software package on the production node to the second revision level.

The method may further include, after upgrading the software package on the production node to the second revision level, redirecting a portion of traffic associated with the software package from the upgraded virtual node to the upgraded production node, and determining if the upgraded production node correctly handles the redirected portion of traffic.

The method may further include, in response to determining that the upgraded production node correctly handled the redirected portion of traffic, redirecting all traffic associated with the software package from the upgraded virtual node to the upgraded production node and determining if the upgraded production node correctly handles the redirected all traffic, and in response to determining that the upgraded production node correctly handled the redirected all traffic, releasing the upgraded virtual node.

Redirecting all traffic associated with the software package from the upgraded virtual node to the upgraded production node may be performed during a low traffic period.

The method may further include, in response to determining that the upgraded production node did not correctly handle the redirected traffic, redirecting all traffic from the upgraded production node to the upgraded virtual node, downgrading the software package in the production node to the first revision level, redirecting all traffic from the upgraded virtual node to the downgraded production node, and downgrading the software package in the upgraded virtual node to the first revision level.

The method may further include, in response to determining that the upgraded virtual node did not correctly handle the redirected portion of traffic, redirecting the redirected portion of traffic back to the production node, and downgrading the software package in the upgraded virtual node to the first revision level.

The method may further include providing a second virtual node, installing the software package with the first revision level on the second virtual node, copying configuration data from the production node to the second virtual node, and redirecting all traffic associated with the software package from the production node and the upgraded first virtual node to the second virtual node in response to a failure of both the upgraded first virtual node and the upgraded production node.

Copying configuration data from the production node to the virtual node may include extracting configuration data from the production node, adapting the configuration data for the virtual node, and writing the adapted configuration data to the virtual node.

Redirecting the portion of traffic associated with the software package from the production node to the virtual node may be performed before upgrading the software package on the virtual node to the second revision level.

A software upgrade system according to some embodiments includes a node cloner configured to create a node that is a virtual clone of a production node having a software package having a first revision level installed thereon, a network controller configured to upgrade the software package on the virtual node to a second revision level, and a traffic redirector configured to redirect a portion of traffic associated with the software package from the production node to the upgraded virtual node. The network controller is configured to determine if the upgraded virtual node correctly handles the redirected portion of traffic.

The network controller is further configured, in response to determining that the upgraded virtual node correctly handled the redirected portion of traffic, to cause the traffic redirector to redirect all traffic associated with the software package from the production node to the upgraded virtual node. The network controller is further configured to determine if the upgraded virtual node correctly handles the redirected all traffic, and, in response to determining that upgraded the virtual node correctly handled the redirected all traffic, to upgrade the software package on the production node to the second revision level.

The network controller is further configured, after upgrading the software package on the production node to the second revision level, to cause the traffic redirector to redirect a portion of traffic associated with the software package from the upgraded virtual node to the upgraded production node, and to determine if the upgraded production node correctly handles the redirected portion of traffic.

The network controller is further configured, in response to determining that the upgraded production node correctly handled the redirected portion of traffic, to cause the traffic redirector to redirect all traffic associated with the software package from the upgraded virtual node to the upgraded production node and to determine if the upgraded production node correctly handles the redirected all traffic, and, in response to determining that the upgraded production node correctly handled the redirected all traffic, to release the upgraded virtual node.

The network controller is configured to redirect all traffic associated with the software package from the upgraded virtual node to the upgraded production node during a low traffic period.

The network controller is further configured, in response to determining that the upgraded production node did not correctly handle the redirected traffic, to cause the traffic redirector to redirect all traffic from the upgraded production node to the upgraded virtual node, to downgrade the software package in the production node to the first revision level, to cause the traffic redirector to redirect all traffic from the upgraded virtual node to the downgraded production node, and to downgrade the software package in the upgraded virtual node to the first revision level.

The network controller is further configured, in response to determining that the upgraded virtual node did not correctly handle the redirected portion of traffic to cause the traffic redirector to redirect the redirected portion of traffic back to the production node, and to downgrade the software package in the virtual node to the first revision level.

The network controller may be further configured to provide a second virtual node, and to install the software package with the first revision level on the second virtual node. The node cloner is configured to copy configuration data from the production node to the second virtual node, and the network controller is configured to cause the traffic redirector to redirect all traffic associated with the software package from the upgraded production node and the upgraded first virtual node to the second virtual node in response to a failure of both the upgraded first virtual node and the upgraded production node.

The node cloner may be configured to copy configuration data from the production node to the virtual node by extracting configuration data from the production node, adapting the configuration data for the virtual node, and writing the adapted configuration data to the virtual node.

### BRIEF DESCRIPTION OF THE DRAWINGS

The accompanying drawings, which are included to provide a further understanding of the disclosure and are incorporated in and constitute a part of this application, illustrate certain non-limiting embodiments. In the drawings:

FIG. 1 illustrates a system for upgrading software in a live system according to some embodiments.

FIG. 2 illustrates components of a node cloner according to some embodiments.

FIG. 3 illustrates components of a traffic redirector according to some embodiments.

FIGS. 4-6 illustrate operations of various elements of a software upgrade system according to some embodiments.

FIGS. 7A-7C illustrate operations of various elements of a software upgrade system according to further embodiments.

FIG. 8 illustrates a system for upgrading software in a live system according to further embodiments.

FIG. 9 illustrates certain elements of a telecommunication network in which embodiments of the invention may be advantageously employed.

FIGS. 10-11 illustrate various aspects of a software upgrade process in a network as illustrated in FIG. 9.

### DETAILED DESCRIPTION

The inventive concepts are described more fully hereinafter with reference to the accompanying drawings, in which embodiments of various aspects of the inventive concepts are shown. The inventive concepts may, however, be embodied in many different forms and is not to be construed as limited to the embodiments set forth herein.

Current approaches for upgrading software on a live telecommunication network system may be subject to one or more of the following concerns: (a) any unforeseen software faults encountered during a software upgrade may result in costly traffic downtime; (b) maintaining a full scale test environment may be cost prohibitive; (c) test environments may not have the same configuration as the live system; thus, it may not be possible to anticipate faults caused by specific configuration issues; and (d) in an upgrade project timeline, the planning phase may be undesirably lengthy and/or expensive.

Some embodiments may allow software upgrades to be performed on a node running live traffic with low or no risk. The cloning procedure may allow the target node to have the identical software level and configuration of the anchor node (live node). By partially redirecting the live traffic from the anchor node to the target node, only a very small portion of the traffic may be affected should the software upgrade fail.

Moreover, by providing a fallback mechanism, the traffic running on the upgraded cloned node can be restored quickly. By temporarily redirecting all the live traffic to a virtual node, it may be possible to avoid any service interruption as a result of the upgrade being carried out on the live node.

Some embodiments may thereby enable software upgrades to be performed without lengthy planning and preparation efforts. The cost of performing a software upgrade may be significantly decreased due to shorter lead times and the need to involve fewer physical resources.

Some embodiments enable software upgrades to be performed on a live node with reduced risk of system downtime due to software or configuration errors. According to some embodiments, software upgrades can be installed, verified and deployed using virtual nodes in a manner in which errors due to software bugs, configuration problems, or issues with the upgrade procedure itself may have little or no impact on the operation of the system.

According to some embodiments, when it is desired to upgrade a software package on a live node (i.e., an anchor node), the live node is cloned to create a virtual copy of the anchor node. The cloned node is upgraded, and a small portion of the traffic being handled by the node is redirected to the cloned node for software verification purposes. After verification that the upgraded cloned node is functioning properly, all live traffic is redirected to the cloned node.

In order to avoid traffic loss as a result of the upgrade, the anchor node may not be upgraded until it has been verified that the cloned node is functioning properly to handle all of the redirected traffic. Should the upgraded cloned node fail to handle the redirected traffic properly, the traffic may be redirected back to the non-upgraded anchor node for handling while the failure is investigated and corrected. In this manner, system downtime due to upgrade failures may be reduced or minimized.

Once the operation of the upgraded cloned node has been verified, the anchor node may be upgraded. Operation of the anchor node may then be verified in a similar manner, e.g., by first redirecting a portion of live traffic to the upgraded anchor node followed by redirecting all traffic to the upgraded anchor node.

Once the operation of the upgraded anchor node has been verified, the system resources used to create the virtual node may be released.

Some embodiments may also shorten the lead time needed for performing a software upgrade and may allow for fewer resources to be used, thereby significantly decreasing the overall cost of the software upgrades.

### Virtualization

In the field of computing, virtualization refers to the creation, implementation and deployment in a computing system of resources that are logical, rather than physical. Resources, such as hardware, operating system, storage device, and network resources, can be virtualized by a computing system. Full virtualization of all system resources, including processors, memory, and I/O devices, makes it possible, for example, to run multiple operating systems on a single physical platform. In a virtual system, each operating system may be isolated from the others, while a virtual hypervisor coordinates access by the operating systems to the actual physical resources of the system.

The benefits of virtualization can include reduction of hardware cost and power consumption, efficient usage of system resources, and flexible deployment and migration of computing resources, among others. Virtualization technology has been well established for decades. Examples of virtualization products include VMware®, Xen®, Microsoft® Hyper-V and Virtual Iron. Virtualization has been widely adopted in the IT industry, and is gaining more and more attention for use in the telecommunications domain.

A virtualization site refers to a computing system that includes servers with processing capabilities, storage, and memory, and on which one or more physical nodes can be virtualized. Virtualization tools, such as VMware®, KVM and Xen® can be used to create virtual nodes. A production site refers to a deployment of live nodes. In a production site, the live nodes can be implemented as physical nodes, virtual nodes, or a collection of physical and virtual nodes.

### Software Upgrade System

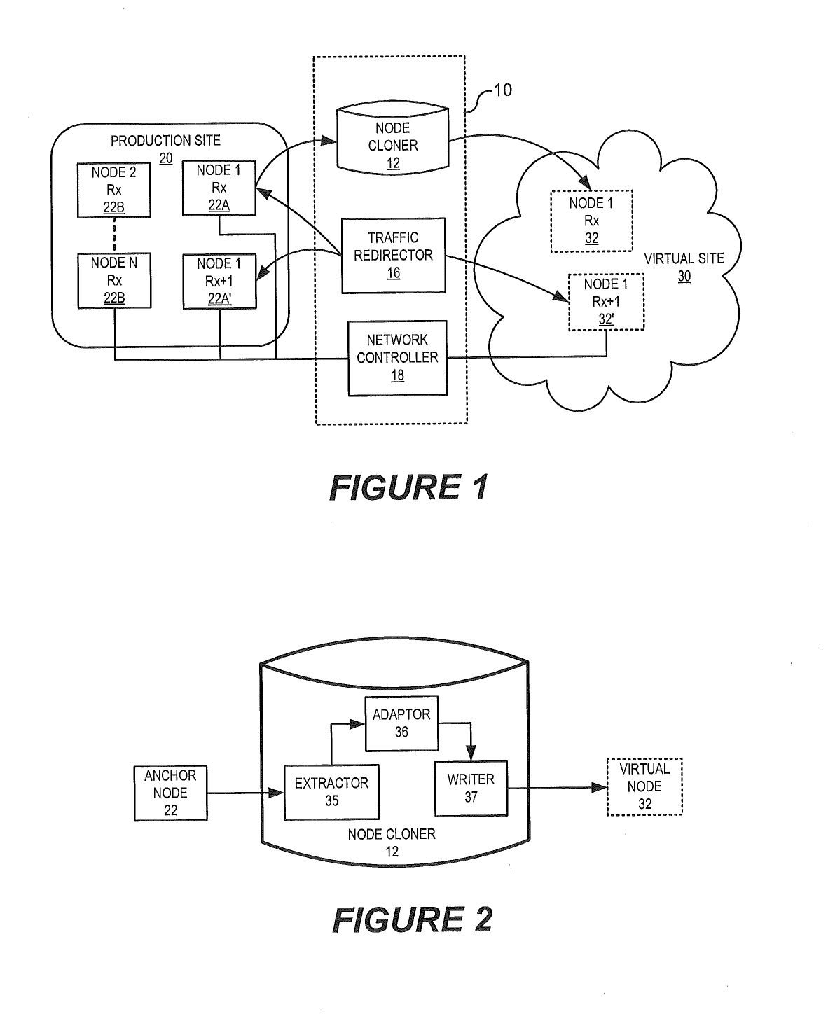

FIG. 1 is a block diagram that illustrates systems/methods according to some embodiments. In particular, FIG. 1 illustrates a software upgrade system 10 that interacts with a production site 20 and a virtual site 30. The production site 20 includes a plurality of operational live nodes including Node 1 22A, and Nodes 2 to N 22B. Each node in the production site 20 has a software revision level Rx. As explained below, the system 10 upgrades Node 1 22A from software revision level Rx to software revision Rx+1. The upgraded version of Node 1 is given reference sign 22A′ in FIG. 1. That is, nodes 22A and 22A′ shown in FIG. 1 are the same node with different software revision levels.

Similarly, in the virtual site, a virtual copy 32 of node 1 is illustrated, along with an upgraded copy 32′ of the virtual copy of node 1.

The software upgrade system 10 includes a node cloner 12, a traffic redirector 16 and a network controller 18.

The network controller 18 controls operations of the software upgrade system 10. In particular, the network controller 18 instructs a virtual hypervisor (not shown) to create a virtual node and its associated virtual resources when it is desired to upgrade a production node.

The node cloner 12 collects and applies configuration information necessary to convert a virtual node into a cloned copy of a node from the production site. That is, once a virtual node has been created, it is necessary to configure the virtual node with the same software and settings as the anchor node before the software upgrade can be implemented on the virtual node. The production node that is cloned is referred to herein as an “anchor node.”

The traffic redirector 16 handles the redirection of traffic to/from the anchor node and the virtual node under the control and direction of the network controller 18.

The network controller 18 also monitors the operations of the anchor node and the virtual node and determines if network traffic is being handled correctly by the upgraded nodes.

### Node Cloner

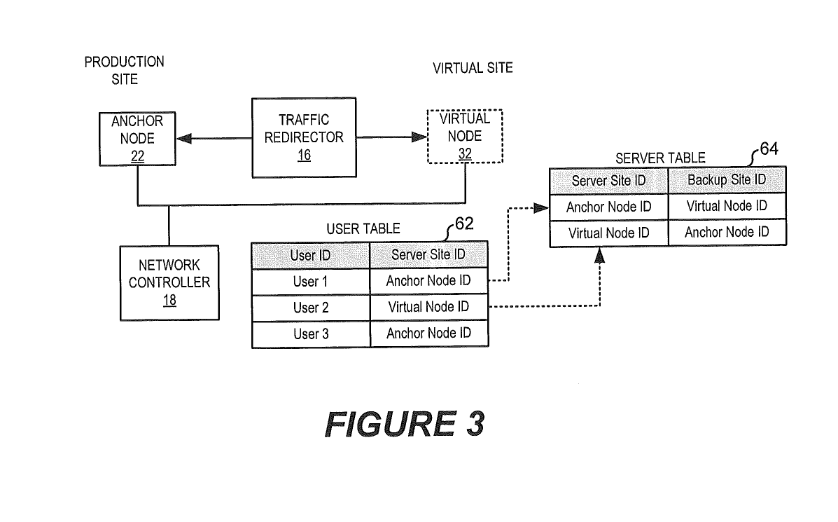

FIG. 2 illustrates various components of a node cloner 12 in accordance with some embodiments. The node cloner 12 includes three functional modules, namely, an extractor module 35, an adaptor module 36 and a writer module 37.

The extractor module 35 is responsible for reading configuration data from an anchor node 22. The extractor module 35 may support data management protocols (e.g. LDAP and NETCONF) provided by anchor node 22. The extractor module generates a configuration file from the configuration data and sends the configuration file to the adaptor module 36. The adaptor module 36 modifies the configuration file using the target node specific data (e.g. IP address and node name), which may be obtained from the network controller 18. The configuration file is then sent to the writer module, which is responsible for parsing the configuration file and writing the configuration data in the configuration to the target virtual node 32 using a protocol that is understood by the target node.

Operations for cloning an anchor node to a target virtual node may include:

1. Obtaining target node adaptation data, e.g. addresses and other node specific data to the target node.

2. Extracting configuration data from the anchor node and generating a configuration file.

3. Modifying the configuration file with information that is specific to the target node.

4. Converting the configuration file back to configuration data and writing the configuration data to the target node.

### Traffic Redirector

Traffic redirection is provided so that traffic can be directed either to the anchor node or the virtual node depending on the current status of a software upgrade. In some embodiments, traffic may be redirected on a per-user basis, a per-session basis, or some other basis.

As noted above, some or all traffic directed to a production node may be redirected to a virtual node, and vice-versa, during a software upgrade process. In addition, if either the production node or the virtual node should fail to handle traffic correctly during the upgrade process, the traffic redirector may automatically cause traffic intended for the failed node to fall back to the other node. In addition, it is desirable that configurations related to the traffic redirection should not otherwise affect the traffic handling on the production site.

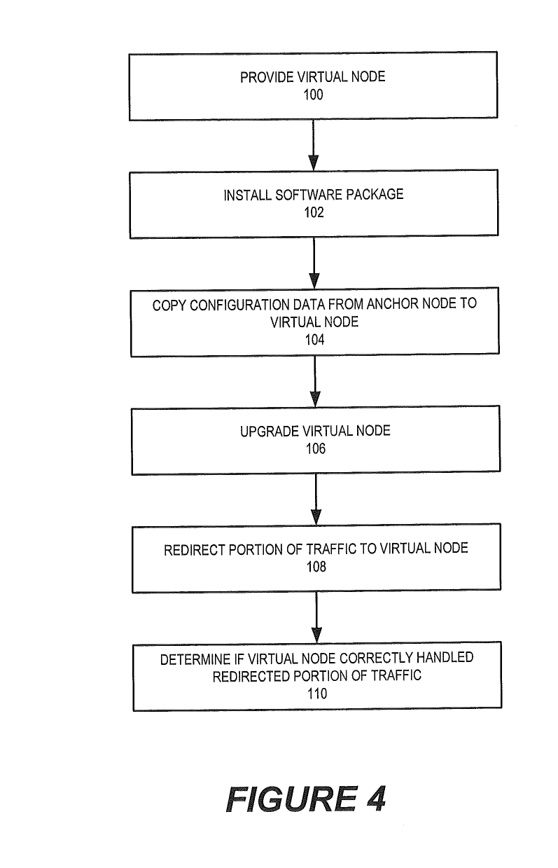

FIG. 3 illustrates a traffic redirection approach according to some embodiments. As shown therein, a traffic redirector 16 maintains a user table 62 that associates users with anchor nodes or target (virtual) nodes and a server table 64 that associates anchor nodes with associated target (virtual) nodes.

As shown in FIG. 3, the anchor node 22 is the node on the production site, which primarily handles the live traffic, while the target node 32 is the node on virtual site, and handles redirected traffic.

The traffic redirector 16 redirects incoming traffic to a destination node that can process the traffic. The traffic redirector 16 can be a standalone entity or a functional block residing in any of the nodes on the physical or virtual sites.

The user table 62 contains mappings between users (identified by user IDs) and anchor nodes (identified by server site IDs). The traffic redirector 16 is deployed so that all network traffic to be handled by a node that is being upgraded is first processed by the traffic redirector 16. When the traffic redirector 16 receives a message, it checks the user ID specified in the message and looks up the server site ID associated with the user ID in the user table 62. It then redirects the traffic to the server site specified by the server ID. For example, in the example shown in FIG. 3, messages from User 1 are routed to the anchor node 22 for processing, while messages from User 2 are routed to the target node 32 for processing.

The traffic redirector 16 also maintains a server table 64 that associates primary servers with backup servers. A single primary server may have one or many backup servers. The primary and backup servers may be identified by the nodes in which they are deployed. Thus, for example, the server table 64 may associates an anchor node ID of the anchor node 22 with a target node ID of the target node 32.

In general, if a primary server is not responding, the traffic redirector 16 can forward traffic that is bound for the primary server to a backup server instead. This allows for automatic fallback of traffic, for example, to the anchor node 22 in case traffic handling on the target node 32 fails during the upgrade process.

The target node 32 may also be connected to the network controller, which allows for the verification of statistics and charging data.

The traffic redirector may required when traffic is partially redirected to a node on the virtual or the production site. The redirector can also be used for full traffic redirection; however, other methods, such as changing network configurations, may be more efficient because there would be no need to consult a table to find a destination server for each user.

### Software Upgrade Process

According to some embodiments, virtual nodes may be used during a software upgrade process to reduce and/or minimize traffic loss and/or service interruptions during the upgrade process. In particular, the upgrade procedures are tested on a virtual node to make sure the upgrade can be successfully installed. After the upgrade has been installed on the virtual node, it may tested with live traffic in order to determine if the upgrade has introduced any incompatibilities or configuration issues.

In addition, while the node on the production site is upgraded, the virtual node can temporarily take over the traffic that is bound for the production node. From the standpoint of a user of the services provided by the node, there appears to be no change in the operation of the server. This may ensure that the upgrade of the node on the production site can be performed without affecting the availability of the system.

Systems/methods according to some embodiments can handle upgrade failures without affecting system availability. For example, an upgrade failure that occurs when either the virtual node or the production node is being upgraded may not result in any traffic loss or service interruptions. If an upgraded node fails when traffic is redirected to it, automatic fallback mechanisms can ensure that traffic is handled by a known good node. IN such a case only a very small number of users may affected because a small amount of traffic was redirected.

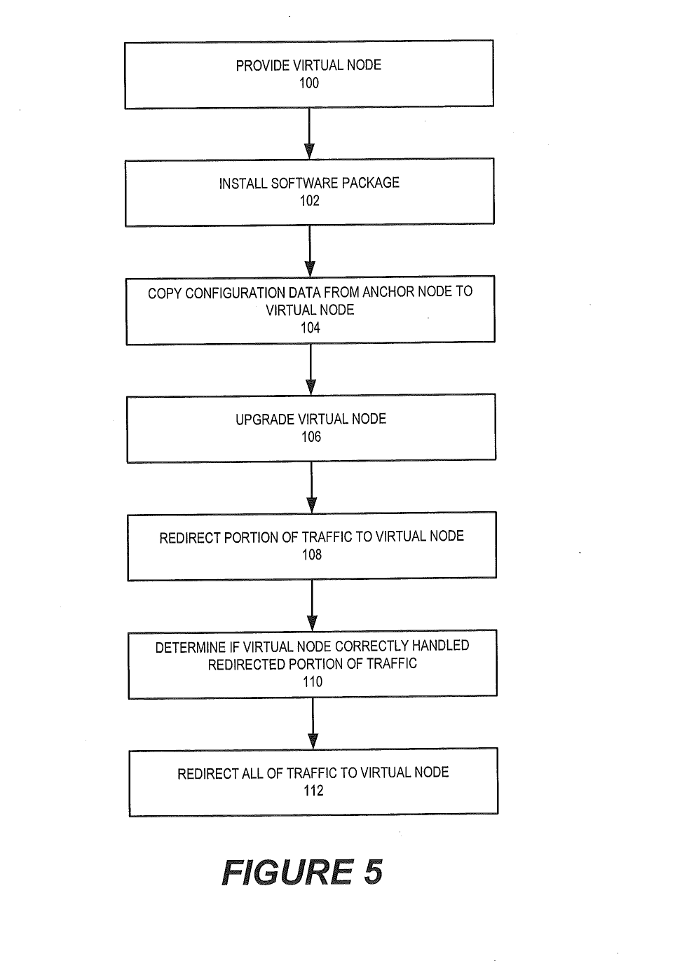

FIG. 4 illustrates operations of a software upgrade system according to some embodiments. Referring to FIGS. 1 and 4, a virtual node 32 is provided (block 100). The virtual node may be established by a virtual hypervisor (not shown) at the request or instruction of the network controller 18. The virtual node 32 is provided with the same software revision level (Rx) as the anchor node 22A on the production site 20. Enough resources should be reserved on the virtual site for the node upgrade and to facilitate handling of traffic that will be redirected to the virtual node 32 after it is upgraded.

Next, the anchor node 22A is cloned by copying the configuration data of the anchor node 22A from the production site to the virtual site (block 104). Examples of the kinds of configuration data that is cloned to the virtual node include subscription profiles, session profiles, service triggers, routing configurations, etc.

The virtual node 32 on virtual site is then upgraded to the upgraded software revision level Rx+1 (block 106). If upgrade fails to install correctly, the upgraded virtual node 32′ may be rolled back to the previous software revision level Rx while the upgrade package is fixed. This process may be repeated until the upgrade is successfully installed.

The upgraded virtual node 32′ is then connected to the live system, and the traffic redirector 16 configures the user table 62 and the server table 64 to handle traffic redirection and automatic fallback to/from the virtual node 32. At this point, the network controller may verify that the configuration does not affect the live system.

The upgraded software is then verified by redirecting a portion of traffic bound for the anchor node 22A to the upgraded virtual node 32′ instead (block 108). The redirected portion of traffic may include some, but less than all, traffic that was originally destined for the anchor node 22A. It is then determined if the virtual node correctly handled the redirected portion of the traffic (block 110).

If the upgraded virtual node 32′ fails to handle the redirected portion of traffic, the traffic redirector 16 may cause traffic to automatically fall back to the anchor node 22A on the production site by changing the appropriate entry in the user table 62 based on the corresponding entry in the server table 64. The software revision level of the virtual node 32 may then be rolled back, and the software upgrade may be fixed. This process may be repeated until the upgraded virtual node 32′ is capable of properly handling the redirected portion of traffic.

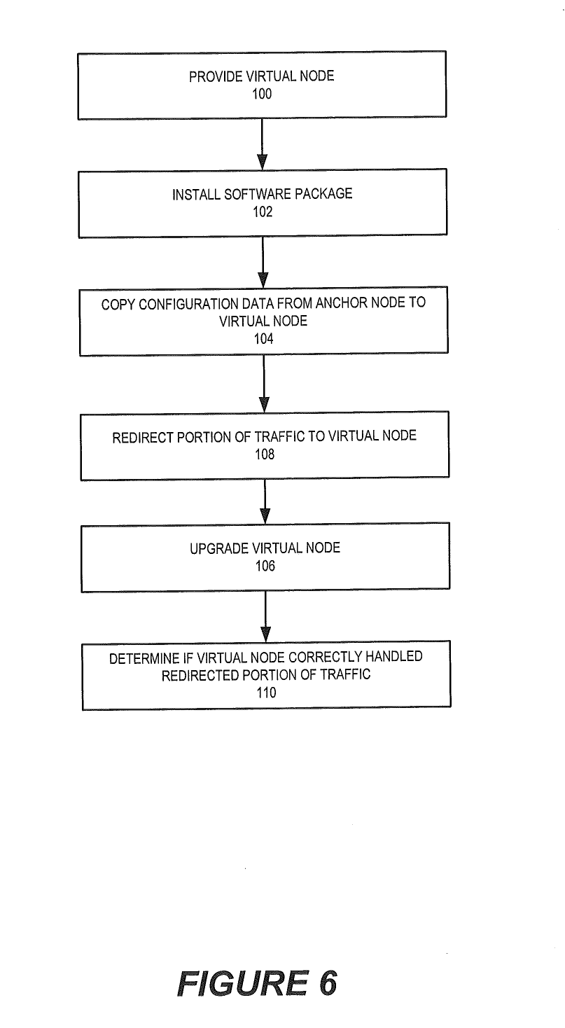

FIG. 5 illustrates operations according to further embodiments. The operations illustrated in FIG. 5 include blocks 100 to 110 as described above in connection with FIG. 4. As shown in FIG. 5, after verification that the upgraded virtual node 32′ is capable of correctly handling the redirected portion of traffic, the traffic redirector 16 may redirect all traffic destined for the anchor node 22A instead to the upgraded virtual node 32′ (block 112). The redirection of all traffic to the upgraded virtual node 32′ may, for example, be performed in a maintenance window (i.e. during low traffic hours).

If the upgraded virtual node 32′ is capable of handling all of the redirected traffic, then the anchor node 22A on the production site may be upgraded to the new software revision level Rx+1. If upgrade of the anchor node 22A fails to install correctly, the anchor node may be rolled back to the previous software revision level, and all traffic may be redirected back to the anchor node 22A at the production site. Once the upgrade is fixed, the upgrade process may be re-started again from block 106.

If the upgrade is successfully installed on the anchor node 22A′, traffic may be partially redirected to the upgraded anchor node 22A′ from the upgraded virtual node 32′. If the upgraded anchor node 22A′ fails to handle the traffic correctly, all traffic may be redirected back to the virtual node 32′ while the anchor node 22A′ is rolled back to the previous software revision level. After the anchor node 22A′ has been rolled back to the previous software revision level, all traffic may be redirected back to the anchor node 22A while the upgrade is fixed, and the upgrade process may be re-started from block 106.

Once the upgraded anchor node 22A′ has been shown to be able to successfully handle the redirected portion of traffic, all of the traffic may be redirected back to the upgraded anchor node 22A′, and the resources on virtual site may be released. The software on virtual site may optionally be packaged and stored for other uses.

These operations may be repeated for each of the remaining nodes 22B on the production site.

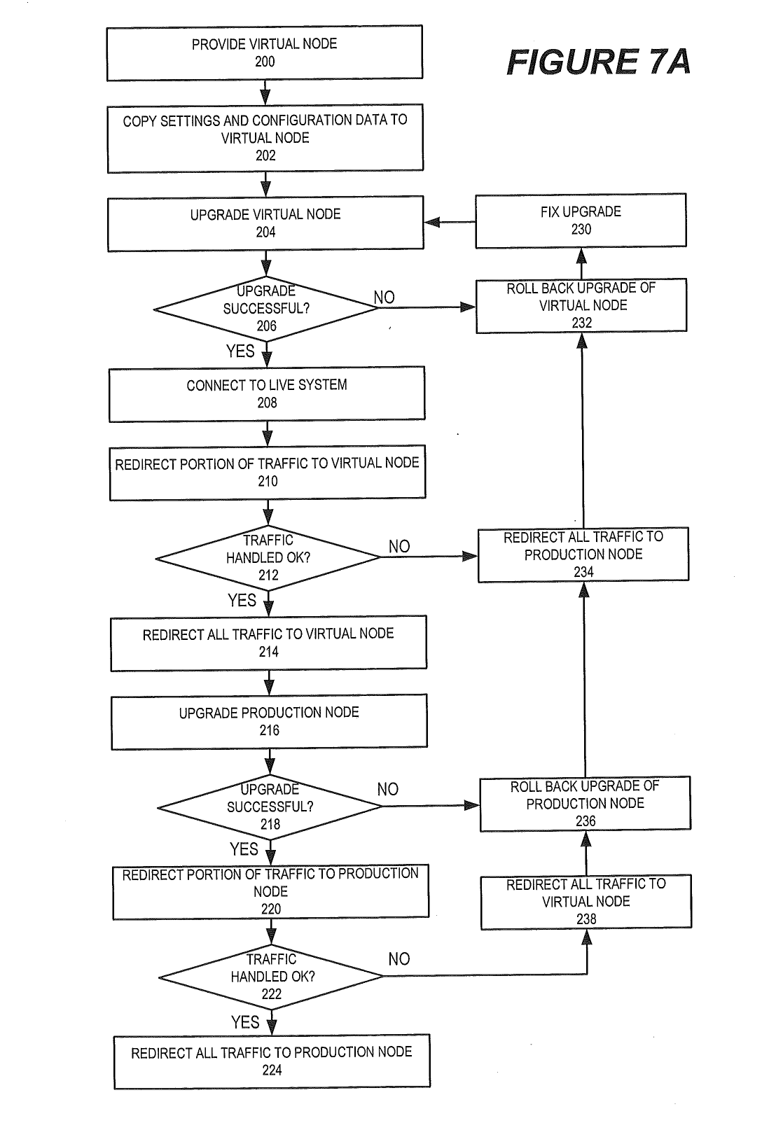

FIG. 6 illustrates operations according to further embodiments. The operations of FIG. 6 are similar to FIG. 5, except that in FIG. 6, a portion of traffic is redirected to the virtual node 32 before the virtual node is upgraded. The virtual node 32 is then upgraded while it handles traffic to verify that the upgrade can be performed on a live node while it is active. That is, some types of upgrades may be designed to be performed on an active node. Such upgrades may include, for example, updating configuration information, updating tables, etc. If the upgraded virtual node cannot properly process traffic, the traffic redirector 16 may automatically redirect traffic to a backup server as specified in the server table 64 while the virtual node is rolled back to the previous software revision level and the upgrade is fixed.

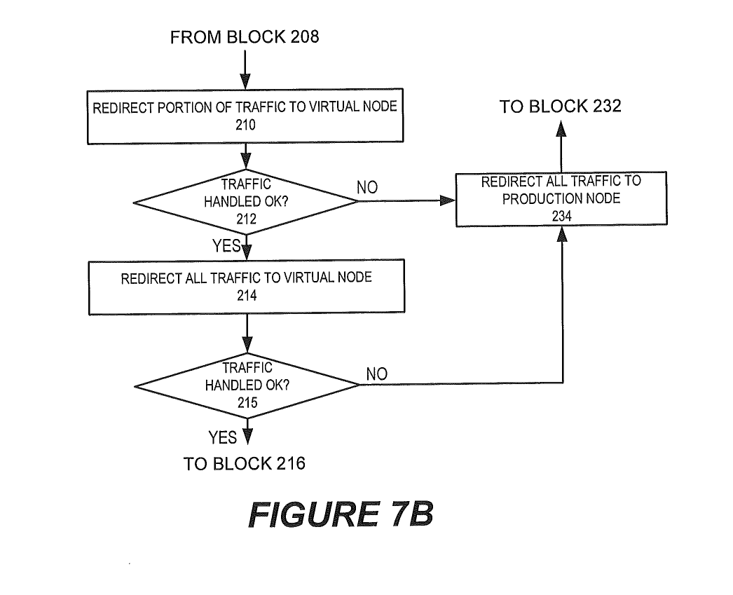

FIG. 7A illustrates operations according to further embodiments. As shown therein, Referring to FIGS. 1 and 7A, a virtual node 32 is provided (block 200). The virtual node may be established by a virtual hypervisor (not shown) at the request or instruction of the network controller 18. The virtual node 32 is provided with the same software revision level (Rx) as the anchor node 22A on the production site 20.

Next, the anchor node 22A is cloned by copying the configuration data of the anchor node 22A from the production site to the virtual site (block 202).

The virtual node 32 on virtual site is then upgraded to the upgraded software revision level Rx+1 (block 204). At block 206, it is determined if the upgrade was successfully installed. If the upgrade fails to install correctly, the upgraded virtual node 32′ may be rolled back to the previous software revision level Rx (block 232) while the upgrade package is fixed (block 230). This process may be repeated until the upgrade is successfully installed.

If the upgrade installed correctly at block 206, the upgraded virtual node 32′ is then connected to the live system (block 208), and the traffic redirector 16 configures the user table 62 and the server table 64 to handle traffic redirection and automatic fallback to/from the virtual node 32.

The upgraded software is then verified by redirecting a portion of traffic bound for the anchor node 22A to the upgraded virtual node 32′ instead (block 210). The redirected portion of traffic may include some, but less than all, traffic that was originally destined for the anchor node 22A. It is then determined if the virtual node correctly handled the redirected portion of the traffic (block 212).

If the upgraded virtual node 32′ fails to handle the redirected portion of traffic, the traffic redirector 16 may cause traffic to automatically fall back to the anchor node 22A on the production site by changing the appropriate entry in the user table 62 based on the corresponding entry in the server table 64 (block 234). The software revision level of the virtual node 32 may then be rolled back (block 232), and the software upgrade may be fixed (block 230). This process may be repeated until the upgraded virtual node 32′ is capable of properly handling the redirected portion of traffic.

If the upgraded virtual node 32′ successfully handled the redirected portion of traffic, then all traffic destined for the anchor node 22A may be redirected to the upgraded virtual node 32′ (block 214).

The production (anchor) node 22A may then by upgraded to the new software revision level Rx+1 (block 216).

The systems/methods then determine if the upgrade was successfully installed in the anchor node (block 218). If not, the upgrade of the anchor node is rolled back (block 236), and operations proceed back through blocks 234, 232 and 230 to fix the upgrade.

If the upgrade was successfully installed in the anchor node, the traffic redirector 16 redirects a portion of the traffic back from the virtual node to the anchor node (block 220). The systems/methods then determine if the upgraded anchor node 22A′ can successfully handle the redirected portion of traffic (block 222). If so, all of the traffic is then redirected to the upgraded anchor node (block 224), and the virtual resources can be released. If not, then traffic is first redirected back to the upgraded virtual node 32′, the upgrade of the anchor node is rolled back (block 236), all traffic is redirected back to the downgraded anchor node (block 234), the virtual node is rolled back to the previous software revision level (block 232), and the upgrade is fixed before starting the upgrade process over again.

Referring to FIG. 7B, after all traffic is redirected to the virtual node at block 214, an additional check (block 215) can be made to determine if the virtual node correctly handles all of the redirected traffic. If so, operations proceed to block 216 (FIG. 7A). Otherwise, all traffic is redirected to the production node at block 234, and operations proceed to block 232 (FIG. 7A).

Referring to FIG. 7C, after all is redirected to the production node at block 224, an additional check (block 225) can be made to determine if the production node correctly handles all of the redirected traffic. If so, the virtual node may be released (block 226). Otherwise, all traffic is redirected to the virtual node at block 238, and operations proceed to block 236 (FIG. 7A).

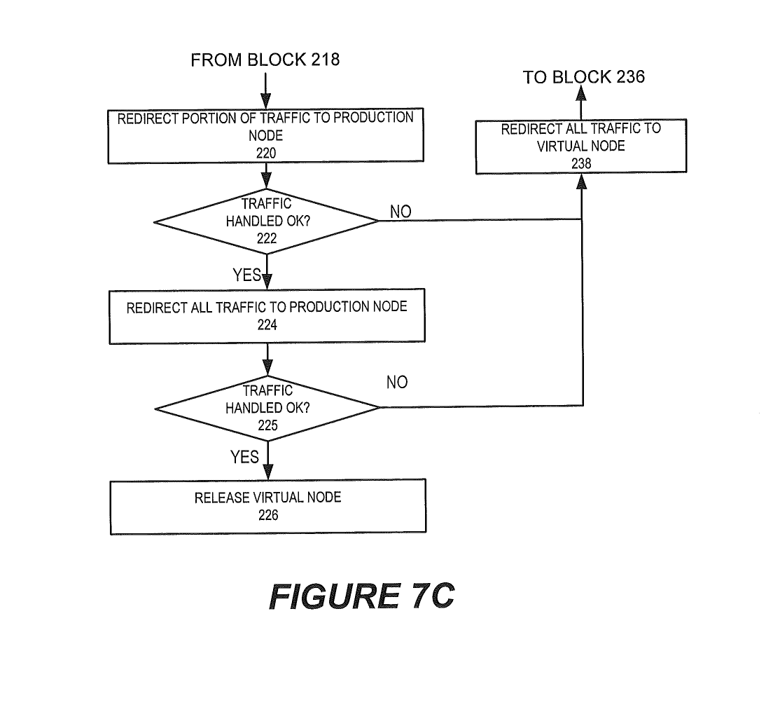

FIG. 8 illustrates systems/methods according to still further embodiments. As shown therein, when a software upgrade is initiated, two virtual nodes 32A, 32B may be cloned from an anchor node 22A. Both virtual nodes 32A and 32B are provided with the same software level and configuration as the anchor node. The upgrade process is conducted using one of the virtual nodes 32A, while the second virtual node 32B is left at the original software revision level during the entire process. The second virtual node 32B is kept as a fallback node in the event that both the upgraded anchor node 22A′ and the upgraded virtual node 32′ fail at the same time.

For example, referring to FIG. 7, at block 216, when the anchor node is upgraded at block 216, both the anchor node 22A′ and the first virtual node 32A′ are at the upgraded software revision level. If the upgraded anchor node 22A′ should fail to correctly handle the redirected portion of traffic at block 222 and the upgraded virtual node 32′ should fail, for example, to correctly handle all of the traffic, then the traffic may be redirected back to the second virtual node 32B, which is at a known good revision level. Thus, the system may be further protected from outage.

### Example Embodiment

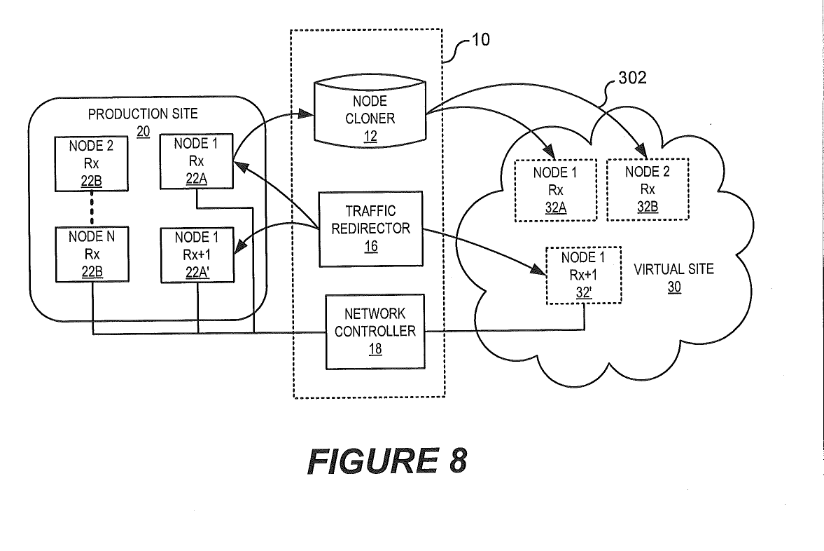

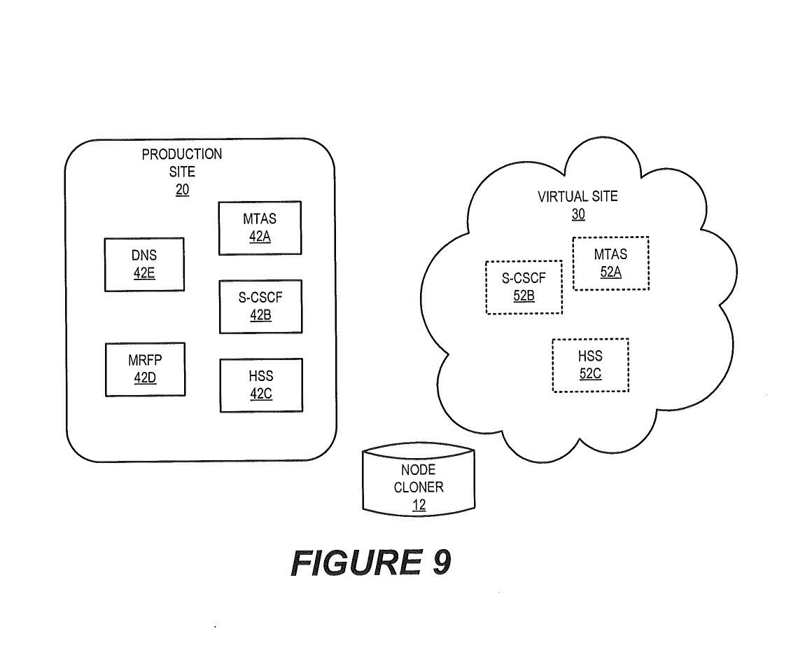

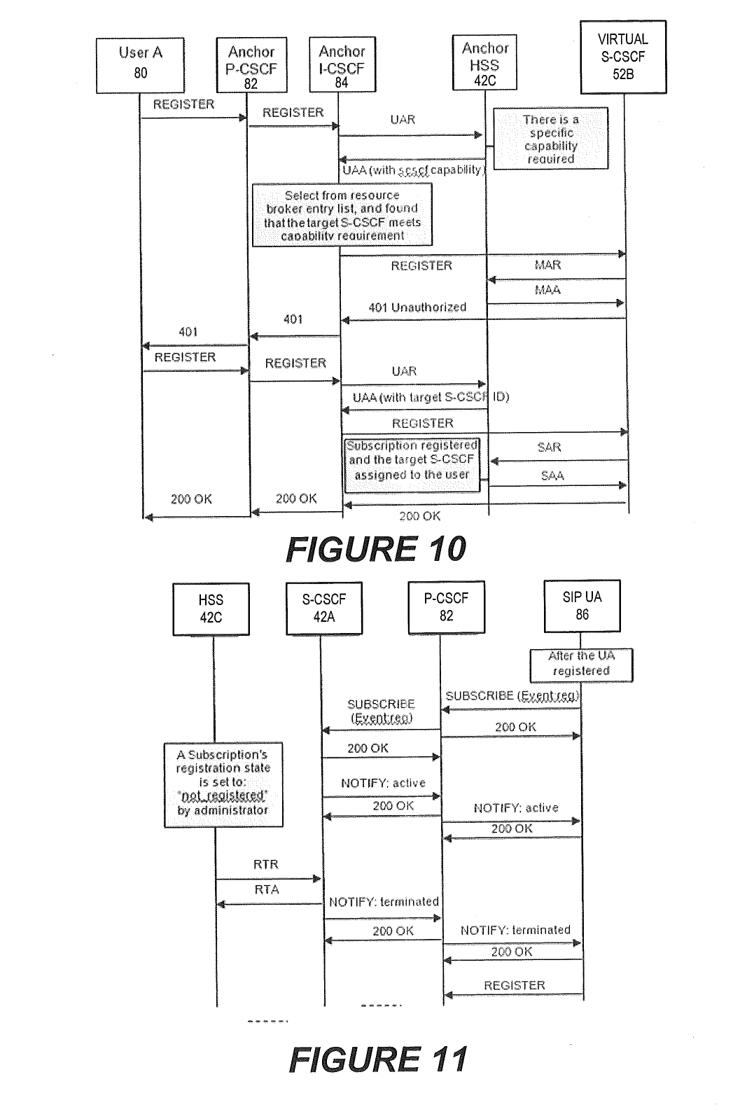

Examples of software upgrade systems/methods in the context of a wireless communication system are illustrated in FIGS. 9-11. In particular, FIG. 9 illustrates certain elements of a telecommunication network in which embodiments of the invention may be advantageously employed, while FIGS. 10-11 illustrate various aspects of a software upgrade process in a network as illustrated in FIG. 9.

FIG. 9 illustrates a production site 20 including a plurality of IP Multimedia Subsystem (IMS) nodes, namely, a multimedia telephony application server (MTAS) node 42A, a serving call session control function (S-CSCF) node 42B, a home subscriber server (HSS) node 42C, a media resource function processor (MFRP) node 42D, and a domain name server (DNS) node 42E. The MTAS node 42E is an IMS application server for voice and multimedia communication services. VMware® ESXi may be used as the virtual hypervisor.

A virtual site 30 is established, and virtual nodes that implement the MTAS node 52A, the S-CSCF node 52B, and the HSS node 52C are installed. The virtual nodes 52A, 52B and 52C are configured with the same software revision level as the corresponding nodes 42A, 42B, 42C on the production site 20. The configuration data of the anchor nodes is cloned to the virtual nodes, and the software is upgraded in accordance with the methods described above. The Ericsson parameter database tool may be used as the node cloner 12.

The traffic redirectors for the S-CSCF, HSS and MTAS nodes may be implemented using different methods, in order to be compliant with the standards, such as 3GPP. For example, the Subscriber Location Function (SLF) may be used as the traffic redirector for the HSS node. The MTAS redirector may be realized using a combination of HSS subscriber service profile entry and S-CSCF application server list. The S-CSCF traffic redirector may be realized using a combination of HSS individual service profile entry and the CSCF resource broker entry. S-CSCF traffic redirection and fallback are described in detail below.

### CSCF Traffic Redirection and Fallback

Referring to FIG. 10, the traffic redirector for the S-CSCF node 42B resides in the anchor Interrogating-CSCF (I-CSCF) 84 and the HSS 42C. The redirection method is based on the following mechanism. A user 80 specifies its individual server capabilities and is stored in the HSS 42C. When querying the HSS 42C, if the server capabilities are received, the I-CSCF 84 selects a Serving-CSCF (S-CSCF) from the resource broker entry based on the capabilities.

A special capability is defined for the target S-CSCF node in the anchor CSCF resource broker list. If users require this server capability, the target S-CSCF would be selected. A user can therefore be configured to be served by the target (virtual) S-CSCF 52B or by the anchor S-CSCF 42B by adding or removing the individual server capability in the HSS 42C. It should be noted that a user may need to re-register if its serving-CSCF has changed.

The traffic automatic fallback mechanism is based on the functionality of prioritizing S-CSCFs in the resource broker entry. The I-CSCF would select an S-CSCF that meets the capability requirement and with a lower priority, if the S-CSCF with a higher priority is not reachable. The traffic automatic fallback to the anchor S-CSCF can be achieved if the anchor S-CSCF 42B is defined as the server with a lower priority and with the same capabilities as what the target S-CSCF 52B has.

FIG. 10 shows a sequence diagram in which a user 80 requires a special server capability that the target S-CSCF 52B provides. The target S-CSCF 52B is therefore assigned to be the serving CSCF for the user.

As shown in FIG. 10, the user 80 sends a REGISTER request to its proxy-CSCF 82, which forwards the request to the interrogating-CSCF 84. The I-CSCF 84 sends a user authorization request (UAR) to the HSS 42C, which responds with a user authorization answer (UAA) with S-CSCF capability. The I-CSCF 84 selects finds a target CSCF that meets the capability requirement and sends a REGISTER request to the selected S-CSCF, which in this case is the virtual S-CSCF node 52B. The S-CSCF node 52B sends a server assignment request (SAR) to the HSS 42C, which responds with a server answer (SAA) and assigns the virtual S-CSCF 52B to the user 80.

### User Re-Registration

User re-registration may be required for CSCF and HSS traffic redirection and fallback. There are two ways of performing re-registration, namely, forced re-registration and expiry-based re-registration. Forced re-registration is performed by system administrator, while expiry-based re-registration is based on the registration expiration time defined in both IMS network and in the SIP User Agent (UA).

In the case of traffic redirection, a forced re-registration is executed. FIG. 11 shows how a user may be forced to re-register. In the scenario, the SIP UA supports RFC 3680 (Session Initiation Protocol (SIP) Event Package for Registrations) and has been configured to subscribe to its registration status. When the registration status in HSS is set to “not registered”, the UA is informed by the Proxy-CSCF (P-CSCF) 82 using the NOTIFY message, which triggers the re-registration.

Some embodiments may allow software upgrades to be performed on a node running live traffic with low or no risk. The cloning procedure may allow the target node to have the identical software level and configuration of the anchor node (live node). By partially redirecting the live traffic from the anchor node to the target node, only a very small portion of the traffic may be affected should the software upgrade fail.

Moreover, by providing a fallback mechanism, the traffic running on the upgraded cloned node can be restored quickly.

By temporarily redirecting all the live traffic to a virtual node, it may be possible to avoid any service interruption as a result of the upgrade being carried out on the live node.

By integrating the target node to the operators backend system it may be possible to perform verification of the statistics data and charging data.

Some embodiments may thereby enable software upgrades to be performed without lengthy planning and preparation efforts. The cost of performing a software upgrade may be significantly decreased due to shorter lead times and the need to involve fewer physical resources.

### ABBREVIATIONS

IMS IP Multimedia Subsystem

CSCF Call Session Control Function

DNS Domain Name Server

HSS Home Subscriber Server

SLF Subscriber Location Function

MTAS Multimedia Telephony Application Server

MFRP Media Resource Function Processor

PDB Parameter Database

NOC Network Operations Center

UAR/UAA User-Authorization-Request/User-Authorization-Answer

MAR/MAA Multimedia-Auth-Request/Multimedia-Auth-Answer

SAR/SAA Server-Assignment-Request/Server-Assignment-Answer

SIP Session Initiation Protocol

UA User Agent

### FURTHER DEFINITIONS

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

What is claimed is:

1. A method of upgrading a software package having a first revision level on a production node, comprising:
providing a virtual node;
installing the software package on the virtual node, the software package having the first revision level;
copying configuration data from the production node to the virtual node;
upgrading the software package on the virtual node to a second revision level to provide an upgraded virtual node;
redirecting a portion of traffic associated with the software package from the production node to the upgraded virtual node; and
determining if the upgraded virtual node correctly handles the redirected portion of traffic.

2. The method of claim 1, further comprising:
in response to determining that the upgraded virtual node correctly handled the redirected portion of traffic, redirecting all traffic associated with the software package from the production node to the upgraded virtual node and determining if the upgraded virtual node correctly handles the redirected all traffic; and
in response to determining that the virtual node correctly handled the redirected all traffic, upgrading the software package on the production node to the second revision level to provide an upgraded production node.

3. The method of claim 2, further comprising:
after upgrading the software package on the production node to the second revision level, redirecting a portion of traffic associated with the software package from the upgraded virtual node to the upgraded production node; and
determining if the upgraded production node correctly handles the redirected portion of traffic.

4. The method of claim 3, further comprising:
in response to determining that the upgraded production node correctly handled the redirected portion of traffic, redirecting all traffic associated with the software package from the upgraded virtual node to the upgraded production node and determining if the upgraded production node correctly handles the redirected all traffic; and
in response to determining that the upgraded production node correctly handled the redirected all traffic, releasing the virtual node.

5. The method of claim 4, wherein redirecting all traffic associated with the software package from the upgraded virtual node to the upgraded production node is performed during a low traffic period.

6. The method of claim 3, further comprising:
in response to determining that the upgraded production node did not correctly handle the redirected traffic:
redirecting all traffic from the upgraded production node to the upgraded virtual node;
downgrading the software package in the upgraded production node to the first revision level to provide a downgraded production node;
redirecting all traffic from the upgraded virtual node to the downgraded production node; and
downgrading the software package in the upgraded virtual node to the first revision level to provide a downgraded virtual node.

7. The method of claim 1, further comprising:
in response to determining that the upgraded virtual node did not correctly handle the redirected portion of traffic:
redirecting the redirected portion of traffic back to the production node; and
downgrading the software package in the upgraded virtual node to the first revision level to provide a downgraded virtual node.

8. The method of claim 1, wherein the virtual node comprises a first virtual node, the method further comprising:
providing a second virtual node;
installing the software package on the second virtual node, the software package having the first revision level;
copying configuration data from the production node to the second virtual node; and
redirecting all traffic associated with the software package from the production node and the first virtual node to the second virtual node in response to a failure of both the first virtual node and the production node.

9. The method of claim 1, wherein copying configuration data from the production node to the virtual node comprises:
extracting configuration data from the production node;
adapting the configuration data for the virtual node; and
writing the adapted configuration data to the virtual node.

10. The method of claim 1, wherein redirecting the portion of traffic associated with the software package from the production node to the upgraded virtual node is performed before upgrading the software package on the virtual node to the second revision level.

11. A software upgrade system, comprising:
a node cloner configured to create a virtual node that is a clone of a production node having a software package having a first revision level installed thereon;
a network controller configured to upgrade the software package on the virtual node to a second revision level to provide an upgraded virtual node; and
a traffic redirector configured to redirect a portion of traffic associated with the software package from the production node to the virtual node;
wherein the network controller is configured to determine if the upgraded virtual node correctly handles the redirected portion of traffic.

12. The software upgrade system of claim 11, wherein the network controller is further configured, in response to determining that the upgraded virtual node correctly handled the redirected portion of traffic, to cause the traffic redirector to redirect all traffic associated with the software package from the production node to the upgraded virtual node;
wherein the network controller is further configured to determine if the upgraded virtual node correctly handles the redirected all traffic, and, in response to determining that the upgraded virtual node correctly handled the redirected all traffic, to upgrade the software package on the production node to the second revision level to provide an upgraded production node.

13. The software upgrade system of claim 12, wherein the network controller is further configured, after upgrading the software package on the production node to the second revision level, to cause the traffic redirector to redirect a portion of traffic associated with the software package from the upgraded virtual node to the upgraded production node, and to determine if the upgraded production node correctly handles the redirected portion of traffic.

14. The software upgrade system of claim 13, wherein the network controller is further configured, in response to determining that the upgraded production node correctly handled the redirected portion of traffic, to cause the traffic redirector to redirect all traffic associated with the software package from the upgraded virtual node to the upgraded production node and determining if the upgraded production node correctly handles the redirected all traffic, and, in response to determining that the upgraded production node correctly handled the redirected all traffic, to release the virtual node.

15. The software upgrade system of claim 14, wherein the network controller is configured to redirect all traffic associated with the software package from the virtual node to the upgraded production node during a low traffic period.

16. The software upgrade system of claim 14, wherein the network controller is further configured:
in response to determining that the upgraded production node did not correctly handle the redirected traffic:
to cause the traffic redirector to redirect all traffic from the upgraded production node to the upgraded virtual node;
to downgrade the software package in the upgraded production node to the first revision level to provide a downgraded production node;
to cause the traffic redirector to redirect all traffic from the virtual node to the downgraded production node; and
to downgrade the software package in the upgraded virtual node to the first revision level to provide a downgraded virtual node.

17. The software upgrade system of claim 11, wherein the network controller is further configured:
in response to determining that the upgraded virtual node did not correctly handle the redirected portion of traffic:
to cause the traffic redirector to redirect the redirected portion of traffic back to the production node; and
to downgrade the software package in the upgraded virtual node to the first revision level to provide a downgraded virtual node.

18. The software upgrade system of claim 11, wherein the virtual node comprises a first virtual node, wherein the network controller is further configured to provide a second virtual node, and to install the software package on the second virtual node, the software package having the first revision level;
wherein the node cloner is configured to copy configuration data from the production node to the second virtual node; and
wherein the network controller is configured to cause the traffic redirector to redirect all traffic associated with the software package from the upgraded production node and the upgraded first virtual node to the second virtual node in response to a failure of both the upgraded first virtual node and the upgraded production node.

19. The software upgrade system of claim 11, wherein the node cloner is configured to copy configuration data from the production node to the virtual node by extracting configuration data from the production node, adapting the configuration data for the virtual node, and writing the adapted configuration data to the virtual node.
